(19) United States
(12) Patent Application Publication
(10) Pub. No.: US 2018/0024513 A1
(43) Pub. Date: Jan. 25, 2018

(54) METHOD OF MANAGING MEASURED DATA AND RELATED DATA MANAGEMENT SYSTEM

(71) Applicant: QISDA CORPORATION, Taoyuan City (TW)

(72) Inventors: Hao-Chun Tung, Taoyuan City (TW); Chen-Chen Tsai, Taoyuan City (TW); Chien-Sen Weng, Taoyuan City (TW); Yung-Ti Wang, Taoyuan City (TW)

(21) Appl. No.: 15/628,657

(22) Filed: Jun. 21, 2017

(30) Foreign Application Priority Data
Jul. 25, 2016 (TW) 105123405

(51) Int. Cl. G05B 15/02

(52) U.S. Cl. CPC G05B 15/02; G05B 2219/36122; G05B 2219/31318

(57) ABSTRACT

In a data management system, a host is configured to send a data access request to a target measurement device among a plurality of measurement devices using a USB dongle. When the USB dongle is unable to receive data from the target measurement device within a predetermined period of time, the host determines that a connection interruption has occurred and releases the connection resource of the USB dongle.

### BACKGROUND OF THE INVENTION

### 1. Field of the Invention

The present invention is related to a method of managing measured data and related data management system, and more particularly, to a method of managing measured data and related data management system capable of improving data efficiency and connection quality.

### 2. Description of the Prior Art

Wearable devices are smart electronic devices that incorporate practical functions and can be worn on human body as implants or accessories. For fitness, sport and health applications, a wearable measurement device may be used to track the physical condition of the wearer, such as monitoring the breath, the heart rate or body motion of the wearer.

A data management system based on wearable measurement devices may be implemented in various applications. For example in a gymnasium, each member may wear a smart watch configured to record the heart rate change during workout. Since wearable measurement devices are normally required to function with highly mobility, the need to improve resource efficiency and connection quality is very important in a data management system.

### SUMMARY OF THE INVENTION

The present invention provides a method of managing measured data. The method includes a host activating a first dongle; the host sending a first data access request to a first measurement device among M measurement devices using the first dongle, wherein M is an integer larger than 1; the host determining whether the first dongle is able to receive first data from the first measurement device within a first predetermined period of time; and the host deciding that a connection interruption has occurred and releasing a connection resource of the first dongle after determining that the first dongle is unable to receive the first data from the first measurement device within the first predetermined period of time.

The present invention also provides a data management system which includes M measurement devices, a first dongle, a second dongle, and a host, wherein M is an integer larger than 1. The host is configured to send a first data access request to a first measurement device among the M measurement devices using the first dongle; determine whether the first dongle is able to receive first data from the first measurement device within a first predetermined period of time; and decide that a connection interruption has occurred and release a connection resource of the first dongle after determining that the first dongle is unable to receive the first data from the first measurement device within the first predetermined period of time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a data management system according to an embodiment of the present invention.

FIG. 2 is a flowchart illustrating a method of managing measured data in the data management system according to an embodiment of the present invention.

### DETAILED DESCRIPTION

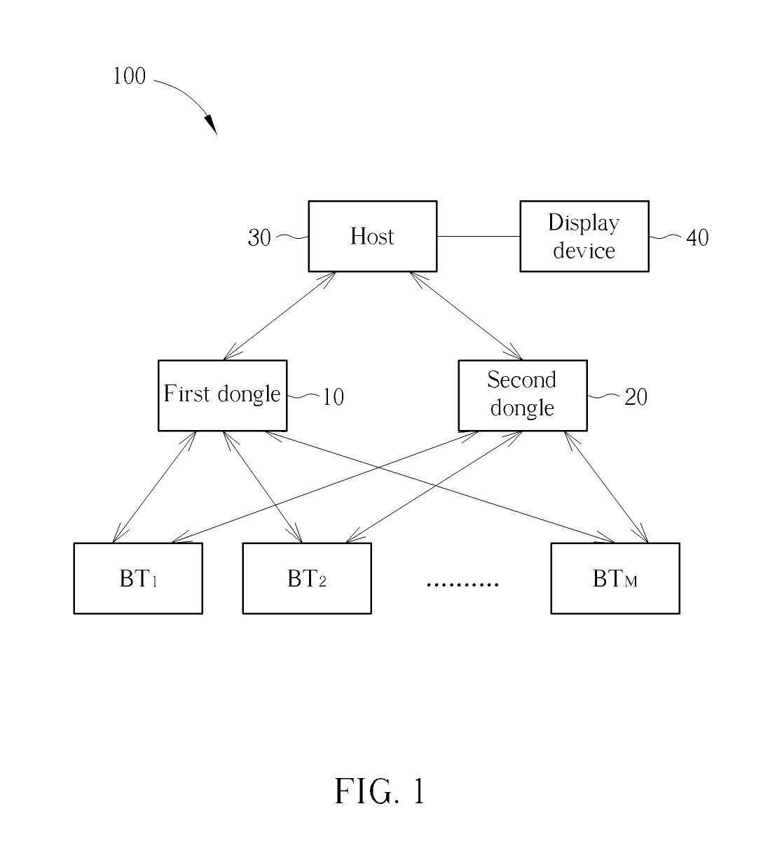

FIG. 1 is a diagram of a data management system 100 according to an embodiment of the present invention. The data management system includes M measurement devices BT₁˜BT_{M} (M is an integer larger than 1), a first dongle 10, a second dongle 20, a host 30, and a display device 40.

In the present invention, the measurement devices BT₁˜BT_{M} may be wearable medical monitor devices in form of watches, necklaces or rings for tracking the physical condition of the wearer anytime and anywhere. The data collected by each measurement device may be the electrocardiogram signals, blood pressure, blood oxygen level, body temperature, brain wave, skin conductance response, or any physical signal of the wearer. However, the type and number of the measurement devices BT₁˜BT_{M} do not limit the scope of the present invention.

In the present invention, the first dongle 10 and the second dongle 20 may be Bluetooth USB dongles, WiFi USB dongles, infrared USB dongles, or other types of dongles. In other embodiments, the data management system 100 may also include more than two dongles. However, the type and number of the dongles do not limit the scope of the present invention.

In the present invention, the host 30 may be a desktop computer, a laptop computer, a mini computer, or any device with central processing capability. The host 30 may establish connections with the measurement devices BT₁˜BT_{M} using the first dongle 10 and the second dongle 20, thereby receiving the data collected by the measurement devices BT₁˜BT_{M}. However, the type of the host 30 does not limit the scope of the present invention.

In the present invention, the display device 40 may adopt liquid crystal display (LCD), plasma display panel (PDP), light emitting diode (LED), organic light emitting display (OLED), field emission display (FED) or electro-phoretic display (EPD) technology. The display device 40 may be implemented as a computer screen, a TV screen, a cellphone screen, a projector or a display board. However, the type of the display device 40 does not limit the scope of the present invention.

In an embodiment of the present invention, the host 30 and the display device 40 are two stand-alone devices connected to each other in a wired or wireless manner so that the host 30 may transmit the data collected by the measurement devices BT₁˜BT_{M} to the display device 40 for displaying the measured data. In another embodiment of the present invention, the host 30 may be integrated in the display device 40 so that the data collected by the measurement devices BT₁˜BT_{M} may directly be shown on the display device 40. However, the implementation of the host 30 and the display device 40 does not limit the scope of the present invention.

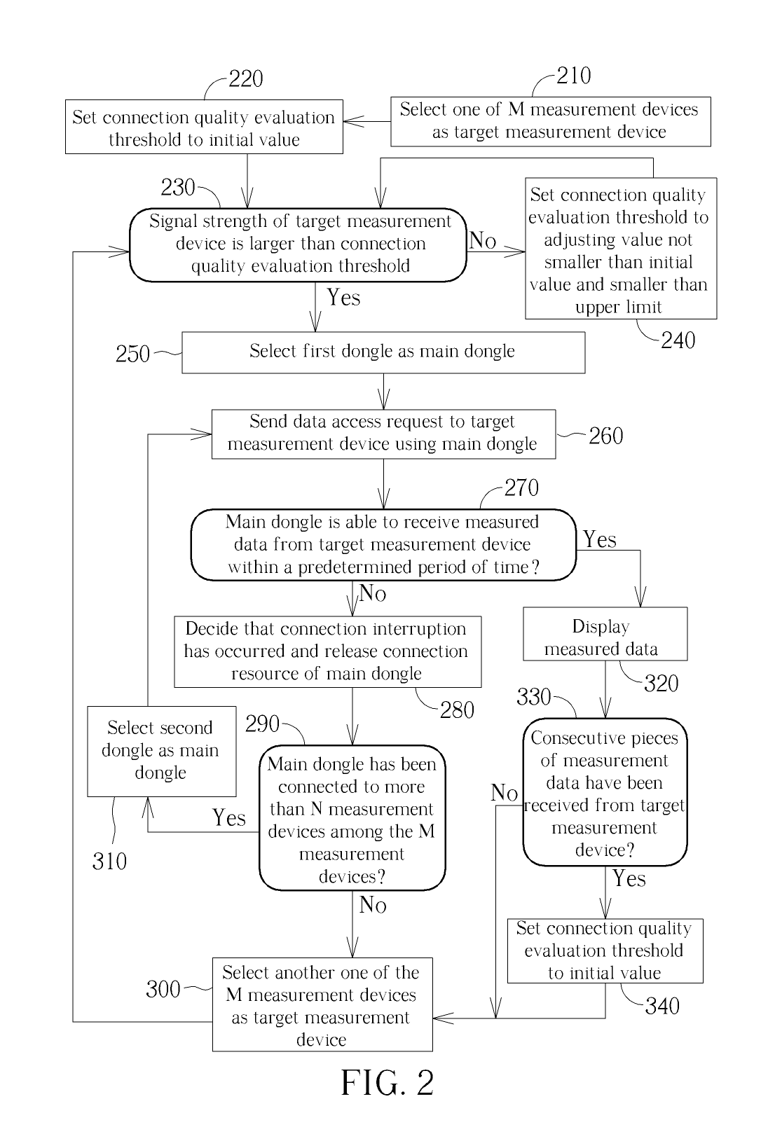

FIG. 2 is a flowchart illustrating a method of managing measured data in the data management system 100 according to an embodiment of the present invention. The method of managing measured data includes the following steps:

Step 210: the host 30 selects one measurement device from M measurement devices as a target measurement device; execute step 220.

Step 220: the host 30 sets a connection quality evaluation threshold to an initial value; execute step 230.

Step 230: the host 30 determines whether the signal strength of the target measurement device is larger than the connection quality evaluation threshold; if yes, execute step 250; if no, execute step 240.

Step 240: the host 30 sets the connection quality evaluation threshold to an adjusting value which is equal to or larger than the initial value and smaller than an upper limit; execute step 230.

Step 250: the host 30 selects the first dongle 10 as the main dongle; execute step 260.

Step 260: the host 30 sends a data access request to the target measurement device using the main dongle; execute step 270.

Step 270: the host 30 determines whether the main dongle is able to receive measured data from the target measurement device within a predetermined period of time; if yes, execute step 320; if no, execute step 280.

Step 280: the host 30 decides that a connection interruption has occurred and releases the connection resource of the main dongle; execute step 290.

Step 290: the host 30 determines whether the main dongle has been connected to more than N measurement devices among the M measurement devices; if yes, execute step 310; if no, execute step 300.

Step 300: the host 30 selects another measurement device from the M measurement devices as the target measurement device; execute step 230.

Step 310: the host 30 selects the second dongle 20 as the main dongle; execute step 260.

Step 320: the display device 40 displays the measured data transmitted by the target measurement device; execute step 330.

Step 330: the host 30 determines whether K consecutive pieces of measurement data have been received from the target measurement device; if yes, execute step 340; if no, execute step 300.

Step 340: the host 30 sets the connection quality evaluation threshold to the initial value; execute step 300.

In steps 210 and 300, the host 30 may select a measurement device from the M measurement devices as the target measurement device. In an embodiment, the administrator or the operator of the data management system 100 may manually issues a user command for requesting one or more specific measurement devices among the M measurement devices to report measured data. Under such circumstance, the host 30 may sequentially set each of the one or more specific measurement devices designated by the user command as the target measurement device. In another embodiment, the host 30 may request one or more specific measurement devices among the M measurement devices to report measured data periodically, at a specific time or randomly according to a pre-stored program code. Under such circumstance, the host 30 may sequentially set each of the one or more specific measurement devices designated by the program code as the target measurement device. However, the method of selecting the target measurement device does not limit the scope of the present invention.

In the present invention, the purpose of the steps 220, 230, 240, 330 and 340 is to confirm that the overall connection quality between the measurement devices and the dongles is sufficiently good. Before sending the data access request to the target measurement device, the host 30 is configured to evaluate the connection quality of the target measurement device based on the connection quality evaluation threshold set to the initial value in steps 220 and 230. When it is determined that the signal strength of the target measurement device does not exceeds the connection quality evaluation threshold, the host 30 is configured to set the connection quality evaluation threshold to the adjusting value which is equal to or larger than the initial value and smaller than the upper limit. Then, step 230 is executed again for evaluating the connection quality of the target measurement device based on the connection quality evaluation threshold set to the adjusted value. When it is determined in step 330 that K consecutive pieces of measurement data have been received from the target measurement device, the host 30 is configured to set the connection quality evaluation threshold to the initial value.

In an embodiment of the present invention, the signal strength of the target measurement device may be a received signal strength indicator (RSSI) parameter. An RSSI parameter with a larger value indicates better connection quality between the measurement devices and the dongles. However, the parameter for evaluating the connection quality between the measurement devices and the dongles does not limit the scope of the present invention.

For illustrative purpose, it is assumed that the host 30 first selects the measurement device BT₁ as the target measurement device in step 210, the connection quality evaluation threshold is set to the initial value of −95 dBm in step 220, and the upper limit is −82 dBm. If the RSSI of the target measurement device BT₁ is smaller than −95 dBm, the measurement device BT₁ may not be able to receive the data access request from the host 30, and the host 30 may not be able to receive the measured data from the measurement device BT₁. Under such circumstance, the host 30 is configured to set the connection quality evaluation threshold to an adjusting value (such as −92 dBm) which is equal to or larger than the initial value (−82 dBm) and smaller than the upper limit (−95 dBm).

Next, it is assumed the host 30 then selects the measurement device BT₂ as the target measurement device in step 300. If the RSSI of the measurement device BT₂ is equal to or larger than −92 dBm, the host 30 is then configured to execute step 250; if the RSSI of the measurement device BT₂ is smaller than −92 dBm, the host 30 is then configured to execute step 240 for setting the connection quality evaluation threshold to an adjusting value (such as −89 dBm). In other words, when the overall signal strength of the M measurement devices is not good enough, the connection quality evaluation threshold is elevated to an adjusted value so that the host 30 only sends the data access request to a target measurement device with a larger RSSI. On the other hand, a high success rate of transmitting data access requests can be expected when the overall signal strength of the M measurement devices is very good. Therefore, when it is determined in step 330 that K consecutive pieces of the measurement data have been received from the target measurement device, the host 30 may then set the connection quality evaluation threshold to the initial value in step 340.

When it is determined that the signal strength of the target measurement device exceeds the connection quality evaluation threshold, the host 30 is configured to select the first dongle 10 as the main dongle in step 250 and then send the data access request to the target measurement device using the main dongle in step 260. When it is determined that the main dongle is able to receive the measured data from the target measurement device within the predetermined period of time in step 270, the display device 40 is configured to display the measured data transmitted by the target measurement device in step 320.

When the connection between the main dongle and the target measurement device somehow fails, the transmission of the measured data may be delayed or lost. Therefore, it may be determined in step 270 that the main dongle is unable to receive the measured data from the target measurement device within the predetermined period of time. Under such circumstance, the host 30 may decide that the connection interruption has occurred and thus releases the connection resource of the main dongle in step 280. This way, unnecessary attempts of the host 30 to establish a connection with an out-of-range target measurement device, which substantially occupy the connection resource of the first dongle 10, may be prevented when the network connectivity is poor or unavailable. Therefore, the present invention can improve the overall resource efficiency by preventing the data management system 100 from remaining in the above-mentioned non-responsive state.

If it is determined in step 290 that the main dongle has been connected to more than N measurement devices among the M measurement devices (N is a positive integer smaller than M), the failure of receiving the measured data from the target measurement device (such as measurement device BT₁) may be caused by the host 30, such as due to overloading. Under such circumstance, the host 30 is configured to select the second dongle 20 as the main dongle. Steps 260-280 may be executed again for attempting to send the data access request to the same target measurement device (such as measurement device device using another dongle (such as the second dongle 20).

If it is determined in step 290 that the main dongle has not been connected to more than N measurement devices among the M measurement devices, the failure of receiving the measured data from the target measurement device (such as measurement device BT₁) may be caused by the target measurement device, such as when the wearer of the target measurement device (such as measurement device BT₁) somehow leaves the effective communication range of the main dongle (such as the first dongle 10). Under such circumstance, the host 30 is configured to select another measurement device among the M measurement devices (such as measurement device BT₂). Step 230 may be executed again for attempting to send the data access request to another target measurement device (such as measurement device BT₂) device using the same dongle (such as the first dongle 10).

The present invention can be applied to any data management system based on wearable measurement devices. For example in a gymnasium, each member may wear a measurement device which records the heart rate change anytime during workout. The present method of managing measured data first confirms that the quality of the connection between the target measurement device and the dongle is sufficiently good before sending the data access request to the target measurement device. When the wearer of the target measurement device somehow leaves the effective communication range, the present method can present the unnecessary attempt of the dongle to establish a connection with the out-of-range target measurement device. Therefore, the present invention can improve the resource efficiency and the connection quality of the data management system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing measured data, comprising:
a host activating a first dongle;
the host sending a first data access request to a first measurement device among M measurement devices using the first dongle, wherein M is an integer larger than 1;
the host determining whether the first dongle is able to receive first data from the first measurement device within a first predetermined period of time; and
the host deciding that a connection interruption has occurred and releasing a connection resource of the first dongle after determining that the first dongle is unable to receive the first data from the first measurement device within the first predetermined period of time.

2. The method of claim 1, further comprising:
the host determining whether the first dongle has been connected to more than N measurement devices among the M measurement devices after releasing the connection resource of the first dongle, wherein N is a positive integer smaller than or equal to M;
the host activating a second dongle after determining that the first dongle has been connected to more than the N measurement devices among the M measurement devices; and
the host sending a second data access request to the first measurement device.

3. The method of claim 1, further comprising:
the host determining whether the second dongle is able to receive second data from the first measurement device within a second predetermined period of time; and
the host deciding that the connection interruption has occurred and releasing a connection resource of the second dongle after determining that the second dongle is unable to receive the second data from the first measurement device within the second predetermined period of time.

4. The method of claim 1, further comprising:
the host determining whether the first dongle has been connected to more than N measurement devices among the M measurement devices after releasing the connection resource of the first dongle, wherein N is a positive integer smaller than or equal to M; and
the host sending a second data access request to a second measurement devices among the M measurement devices using the first dongle after determining that the first dongle has not been connected to more than the N measurement devices among the M measurement devices.

5. The method of claim 4, further comprising:
the host determining whether the first dongle is able to receive second data from the second measurement device within the first predetermined period of time; and
the host deciding that the connection interruption has occurred and releasing the connection resource of the first dongle after determining that the first dongle is unable to receive the second data from the second measurement device within the first predetermined period of time.

6. The method of claim 1, further comprising:
the host setting a connection quality evaluation threshold to an initial value;
the host determining whether a signal strength of the first measurement device is larger than the connection quality evaluation threshold before sending the first data access request to the first measurement device; and
the host setting the connection quality evaluation threshold to an adjusting value which is equal to or larger than the initial value when determining that the signal strength of the first measurement device is not larger than the connection quality evaluation threshold.

7. The method of claim 6, further comprising:
the host sending the first data access request to the first measurement device when determining that the signal strength of the first measurement device is larger than the connection quality evaluation threshold;
the host determining whether K consecutive pieces of measurement data have been received from the first measurement device after sending the first data access request to the first measurement device and when determining that the first dongle is able to receive the first data from the first measurement device within the first predetermined period of time, wherein K is an integer larger than 1; and
the host setting the connection quality evaluation threshold to the initial value when determining that the K consecutive pieces of measurement data have been received from the first measurement device.

8. A data management system, comprising:
M measurement devices, wherein M is an integer larger than 1;
a first dongle;
a second dongle; and
a host configured to:
send a first data access request to a first measurement device among the M measurement devices using the first dongle;
determine whether the first dongle is able to receive first data from the first measurement device within a first predetermined period of time; and
decide that a connection interruption has occurred and release a connection resource of the first dongle after determining that the first dongle is unable to receive the first data from the first measurement device within the first predetermined period of time.

9. The data management system of claim 8, wherein the host is further configured to:
determine whether the first dongle has been connected to more than N measurement devices among the M measurement devices after releasing the connection resource of the first dongle, wherein N is a positive integer smaller than or equal to M;
activate a second dongle for sending a second data access request to the first measurement device when determining that the first dongle has been connected to more than the N measurement devices among the M measurement devices; and
send the second data access request to a second measurement device among the M measurement devices using the first dongle when determining that the first dongle has not been connected to more than the N measurement devices among the M measurement devices.

10. The data management system of claim 9, wherein the host is further configured to:
set a connection quality evaluation threshold to an initial value;
determine whether a signal strength of the first measurement device is larger than the connection quality evaluation threshold before sending the first data access request to the first measurement device; and
set the connection quality evaluation threshold to an adjusting value which is equal to or larger than the initial value when determining that the signal strength of the first measurement device is not larger than the connection quality evaluation threshold.

11. The data management system of claim 10, wherein the host is further configured to:
send the first data access request to the first measurement device when determining that the signal strength of the first measurement device is larger than the connection quality evaluation threshold;
determine whether K consecutive pieces of measurement data have been received from the first measurement device after sending the first data access request to the first measurement device and when determining that the first dongle is able to receive the first data from the first measurement device within the first predetermined period of time, wherein K is an integer larger than 1; and
set the connection quality evaluation threshold to the initial value when determining that the K consecutive pieces of measurement data have been received from the first measurement device.

12. The data management system of claim 8, wherein the first dongle and the second dongle are Bluetooth USB dongles, WiFi USB dongle or infrared USB dongles.

13. The data management system of claim 8, wherein the host is further configured to:
determine whether the second dongle is able to receive second data from the first measurement device within a second predetermined period of time; and
decide that the connection interruption has occurred and releasing a connection resource of the second dongle after determining that the second dongle is unable to receive the second data from the first measurement device within the second predetermined period of time.

14. The data management system of claim 8, wherein the host is further configured to:
determine whether the first dongle has been connected to more than N measurement devices among the M measurement devices after releasing the connection resource of the first dongle, wherein N is a positive integer smaller than or equal to M; and
send a second data access request to a second measurement devices among the M measurement devices using the first dongle after determining that the first dongle has not been connected to more than the N measurement devices among the M measurement devices.

15. The data management system of claim 14, wherein the host is further configured to:
determine whether the first dongle is able to receive second data from the second measurement device within the first predetermined period of time; and
decide that the connection interruption has occurred and releasing the connection resource of the first dongle after determining that the first dongle is unable to receive the second data from the second measurement device within the first predetermined period of time.
